(19) United States
(12) Patent Application Publication
(10) Pub. No.: US 2007/0020065 A1
(43) Pub. Date: Jan. 25, 2007

(54) Workpiece holding apparatus

(76) Inventor: Larry D. Kirby, Oklahoma City, OK (US)

Correspondence Address: DUNLAP, CODDING & ROGERS P.C., PO BOX 16370, OKLAHOMA CITY, OK, 73113, US

(21) Appl. No.: 11/493,647

(22) Filed: Jul. 25, 2006

Related U.S. Application Data
(60) Provisional application No. 60/702,124, filed on Jul. 25, 2005.

(51) Int. Cl. B25J 1/00

(52) U.S. Cl. 414/1

(57) ABSTRACT

An apparatus for holding a workpiece having a support table, a plurality of elongated workpiece supports extendible from the support table, a plurality of a clamp assemblies, and a processing machine. Each clamp assembly is positioned about a portion of a corresponding workpiece support. The clamp assemblies are moveable between a clamping position wherein the clamp assemblies support the workpiece support in a selected vertical position and a non-clamping position wherein the workpiece supports are moveable so that the position of the workpiece support is changeable. The processing machine is in communication with the clamp assemblies for controlling the position of the clamp assemblies, and the processing machine has an end effector engageable with the workpiece supports above the support table to permit the processing machine to move the workpiece supports to selected positions when the clamp assemblies are in the non-clamping position.

### CROSS REFERENCE TO RELATED APPLICATIONS

This application claims benefit of U.S. Provisional Application No. 60/702,124, filed Jul. 25, 2005, which is incorporated herein by reference in its entirety.

### BACKGROUND OF THE INVENTION

1. Field of the Invention

This invention relates generally to an apparatus for holding a workpiece. Holding of the workpiece is required while, for example, cutting, machining, assembly or transportation processes are performed.

2. Brief Description of Related Art

In recent years CNC (Computer Numerically Controlled) machine tool and assembly technology has evolved to the extent that it is now relatively easy to perform processes on materials with three-dimensional contours. However, holding the material while the process is being performed can be difficult. There may be a large variety of material sizes and contours that need to be processed. The materials to be processed may be quite large, such as parts for the aerospace industry. Materials, at least at this processing stage, may be relatively flexible, and require support and constraint at as many points as possible across their contoured surfaces.

One method of holding the contoured materials is to construct a dedicated fixture which has the same contour as the material to be processed. With the application of a sealing system, vacuum can be utilized to hold the material to the fixture. Disadvantages of using dedicated fixtures include high construction costs and the need for large amounts of space to store the fixtures. With the numerous disadvantages encountered with dedicated fixtures, efforts have been made to develop universal systems.

Such universal systems typically include a plurality of vertically adjustable members such as rods, pins or tubes arranged in a grid pattern. Each vertically adjustable member normally has a vacuum cup at the extended end which is positioned by some means at a specified Z axis location to form the desired contour. Typically, each of the members is vertically positioned by an actuator associated with the vertically adjustable member. Because of the number of members and actuators required to hold large parts, the cost of such systems can be prohibitive. Otherwise, the adjustable members must be manually adjusted which is extremely labor intensive.

To this end, a need exists for an improved workpiece holding apparatus. It is to such an apparatus that the present invention is directed.

### BRIEF DESCRIPTION OF THE SEVERAL VIEWS OF THE DRAWINGS

FIG. 1 is a perspective view of a workpiece holding apparatus shown supporting a workpiece.

FIG. 2 is a perspective view of a support table shown supporting a plurality of workpiece supports.

FIG. 3 is perspective view of one of the workpiece supports being positioned by a processing machine via an end effector attached to the processing machine.

FIG. 4 is a perspective view of the end effector.

FIG. 5 is an exploded, perspective view of a clamp assembly.

FIG. 6 is a perspective view of the support table shown supporting another embodiment of a plurality of workpiece supports.

FIG. 7 is an end elevational view of the support table and the workpiece supports of FIG. 6.

FIG. 8 is a perspective view of one of the workpiece supports shown disposed through a clamp assembly.

FIG. 9 is a top view of the workpiece support.

FIG. 10 is a cross sectional view taken along line 10-10 of FIG. 9.

FIG. 11 is an exploded, perspective view of a cable clamp assembly.

FIG. 12 is an exploded, perspective view of a pivot clamp assembly and a suction cup assembly.

FIG. 13 is a perspective view of another embodiment of a workpiece holding apparatus shown supporting a workpiece.

FIG. 14 is a sectional view of a workpiece support shown connected to a support table.

FIG. 15 is an enlarged sectional view of a clamp assembly.

FIG. 16 is a side elevational view of an end effector.

FIG. 17 is a perspective view of the workpiece support being positioned by a processing machine via the end effector attached to a processing machine.

### DETAILED DESCRIPTION OF EXEMPLARY EMBODIMENTS OF THE INVENTION

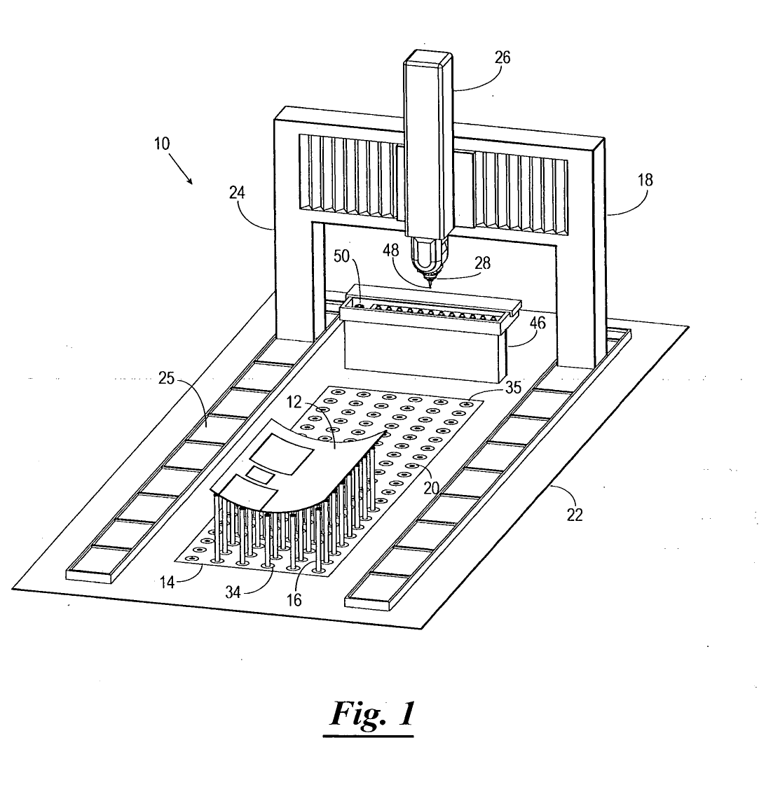

Referring now to the drawings, and more particularly to FIG. 1, a workpiece holding apparatus 10 is shown supporting a workpiece 12. The workpiece holding apparatus 10 includes a support table 14, a plurality of workpiece supports 16 extendible from the support table 14, and a processing machine 18. The workpiece holding apparatus 10 utilizes the processing machine 18, which normally performs the cutting or assembly on the workpiece 12, to position the workpiece supports 16. The workpiece supports 16 are arranged in a linear grid pattern and are linearly adjustable up and down.

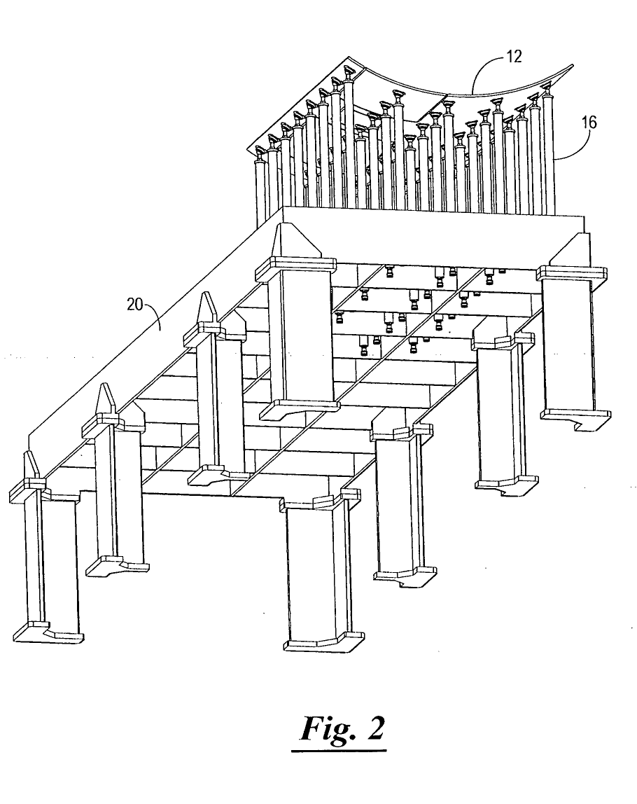

The support table 14 (FIGS. 1 and 2) is provided with a plurality of apertures 20 for receiving the workpiece supports 16. The support table 14 is shown in FIG. 1 to be recessed in a floor 22 such that the top of the support table 14 is flush with the floor 22 to permit the workpiece 12 to be supported at a desired height, for example at approximately 36 inches from the floor 22 to ease loading and unloading of the workpiece 12 from the workpiece holding apparatus 10. It will be appreciated, however, that the support table 14 may be positioned at any height.

The processing machine 18 is illustrated to be a CNC (Computer Numerically Controlled) machine. CNC machines for processing contoured material are typically equipped with XYZ linear axis, together with an additional 2-3 rotary axis having axis designations ABC. Typically the A axis rotates around the X axis, the B axis rotates around the Y axis, and the C axis rotates around the Z axis. Broadly, the processing machine 18 shown in FIG. 1 includes a frame 24 which is moveable along a track 25 and which carries a Z axis stage 26. The Z axis stage 26 carries a machining spindle 28 for processing the workpiece 12. However, it should be appreciated that the processing machine may also be a robot or other machine capable of performing the positioning and machining functions, or capable of performing only the positioning function wherein separate machines would be used to perform the machining processes and the positioning processes.

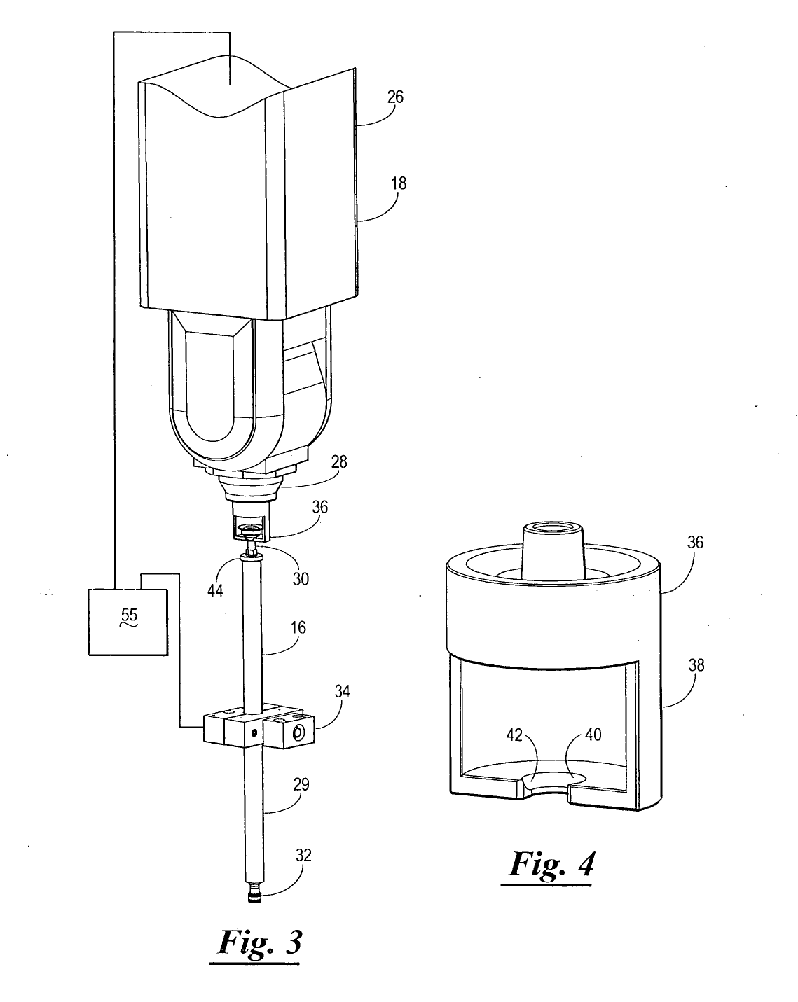

As best shown in FIG. 3, each workpiece support 16 includes a rod member 29 having a suction cup assembly 30 connected to an upper end and hose connector 32 connected to a lower end. The rod member 29 is provided with a longitudinal bore (not shown) to establish fluid communication between the hose connector 32 and the suction cup assembly 30. Vacuum supply hoses (not shown) are routed within the support table 14. The vacuum originates from a means of providing vacuum such as a pump, and then is routed to manifolds within the support table 14 from which vacuum is distributed to each workpiece support 16. Typically the vacuum will be controlled in a plurality of zones relative to the size of the support table 14.

The support table 14 supports a clamp assembly 34 for each aperture 20, which enables clamping of the workpiece support 16 in an infinite number of vertical positions. If an aperture 20 is not utilized to support a workpiece support 16, that aperture 20 may be covered with a plug 35 (FIG. 1). The workpiece supports 16 have no inherent feedback or linear actuation capabilities, but instead rely on the process machine 18 for positioning.

FIG. 3 depicts a workpiece support 16 being positioned by the processing machine 18 via an end effector 36 attached to the processing machine 18. As best shown in FIG. 4, the end effector 36 is a body 38 with an open sided hole 40. The hole 40 is provided with a conical surface 42 contoured to mate with a portion of the suction cup assembly 30 of the workpiece supports 16 whereby gravity is utilized to hold the workpiece supports 16 to the conical surface 42 of the end effector 36.

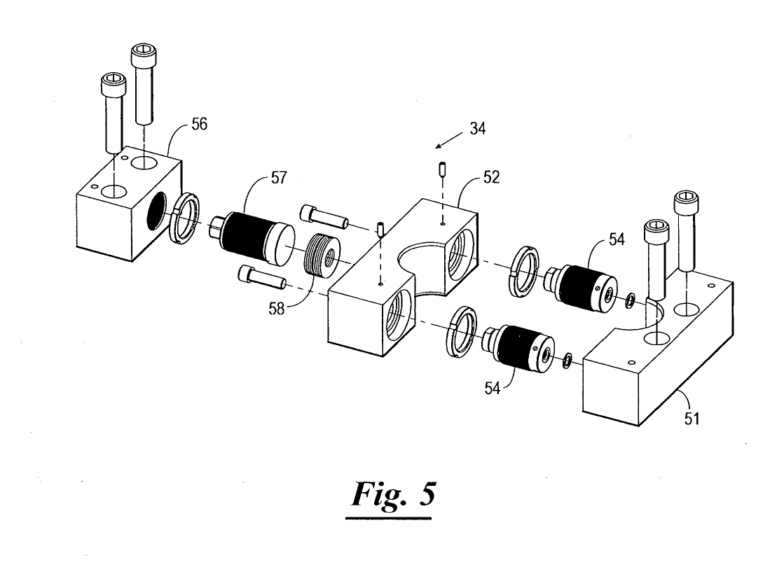

FIG. 5 is an exploded view of a suitable clamp assembly 34, but it should be appreciated that a variety of different types of clamp assemblies may be utilized. The clamp assembly 34 includes a cylinder housing 51 and a spring housing 52 which cooperate to define a workpiece support receiving hole and which are movable relative to one another in response to actuation of a pair of actuators 54. The actuators 54 are actuated by a control system 55 (FIG. 3) of the processing machine 18. The clamp assembly 34 further includes a stop housing 56 which houses a travel adjuster 57 and a spring assembly 58.

The following is an example of a sequence that may be utilized to position a series of workpiece supports 16. This sequence utilizes a CNC machine as the process machine 18 to perform the positioning, but the sequence would be similar if one or more robotic arms were utilized instead. All movements and actuation performed by the processing machine 18 are processed by the control system 55 utilized on that processing machine 18 for common work processing.
1. Processing machine operator removes selected aperture plugs 35 from the support table 14 within XY area encompassed by the workpiece 12 required for processing.
2. Processing machine operator issues a command to the processing machine 18 to actuate clamp assemblies 34 to allow insertion of workpiece supports 16.
3. Processing machine operator removes a plurality of workpiece supports 16 from workpiece support storage rack (not shown) and places workpiece supports 16 into the support table 14 within the XY area encompassed by the workpiece 12 required for processing. Workpiece support shoulder stops 44 are held by gravity against a table aperture flange (not shown).
4. Processing machine operator issues a command to the processing machine 18 to move to an open cutting tool storage position in cutting storage cabinet 46.
5. Processing machine 18 actuates a clamping device of the machining spindle 28 to undock with cutting tool 48.
6. Processing machine 18 moves to end effector storage location 50 and docks with end effector 36, by releasing clamping device of the machining spindle 28.
7. Processing machine 18 with end effector 36 affixed moves to an XY position above workpiece support 16 placed by operator into support table 14.
8. Processing machine 18 lowers its Z axis stage 26 with end effector 36 affixed until the end effector 36 is in the correct Z axis position to mate with the workpiece support 16.
9. Processing machine 18 moves its X axis stage with end effector 36 affixed until the end effector 36 is in the correct X axis position to mate with workpiece support 16.
10. Processing machine 18 raises its Z axis stage 26 until end effector 36 is in close proximity to suction cup assembly 30.
11. Processing machine 18 raises or lowers its Z axis stage 26 which is now supporting workpiece support 16 to a predetermined height corresponding to the contour of the workpiece 12 at this particular XY location.
12. Processing machine 18 releases the clamp assembly 34 to constrain the height of workpiece support 16.
13. Processing machine 18 unmates end effector 36 from workpiece support 16 by moving Z axis stage 26 down until end effector 36 is clear of suction cup assembly 30. The processing machine 18 moves X axis stage until end effector 18 is clear of workpiece support 16.
14. Processing machine 18 moves to a XY position above the next workpiece support 16 which requires vertical positioning.
15. Steps 7-14 are repeated until all workpiece supports 16 requiring positioning within XY area encompassed by the workpiece 12 are positioned.
16. Processing machine 18 moves to end effector storage location 50 and undocks with end effector 36 by releasing the clamping device of the machining spindle 28.
17. Processing machine 18 moves to cutting tool storage position in cutting storage cabinet 46 for first tool required in material process.
18. Processing machine 18 actuates the clamping device of the machining spindle 28 to dock with cutting tool 48.
19. Operator places the workpiece 12 onto the workpiece supports 16 and activates vacuum to hold the suction cup assemblies 30 to the workpiece 12.
20. Processing machine 18 performs normal cutting or assembly processes on the workpiece 12.
21. After the workpiece 12 process is completed the vacuum holding the workpiece 12 to workpiece supports 16 is released by the operator. Operator removes completed workpiece 12.
22. Steps 1-21 are repeated with each workpiece that requires different positioning of workpiece supports 16.

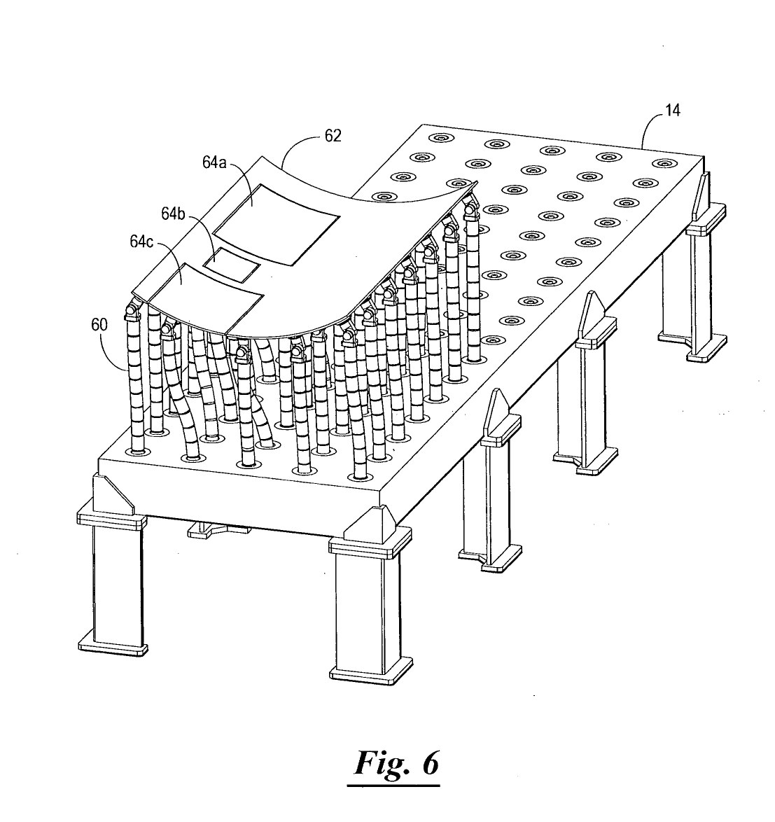

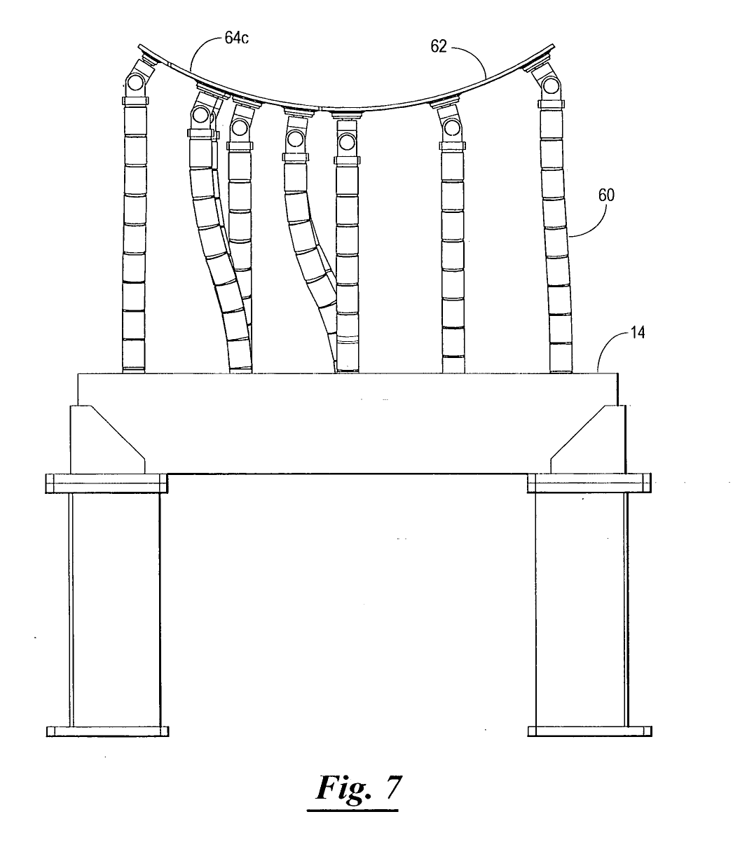

FIGS. 6 and 7 show the support table 14 supporting another embodiment of a plurality of workpiece supports 60. The workpiece supports 60 are characterized as having a flexible condition and a rigid condition. This enables the workpiece supports 60 to be freely positioned in a non-linear configuration along the contoured surfaces of the workpiece 12 with as many degrees of freedom as the processing machine 18 is equipped, thereby enabling the ability to hold a variety of contoured surfaces without interfering with machining processes. That is, the points XY at which the workpiece supports 60 contact the workpiece 62 are not constrained to the aperture spacing of the support table 14. The suction cup clamp portion of the workpiece supports 16 can be freely positioned along the contoured surfaces of the workpiece as shown in FIGS. 6 and 7. This is particularly useful to avoid placement of workpiece supports where there could be an interference with, for example, cutting or riveting paths during part processing. For example, FIGS. 6 and 7 illustrate a workpiece 62 being held by the workpiece supports 60. The workpiece 62 has cut sections represented by reference numeral 64a-64c. The workpiece supports 60 are arranged to be positioned out of the path of the cutter and thereby avoid interference with the cutter.

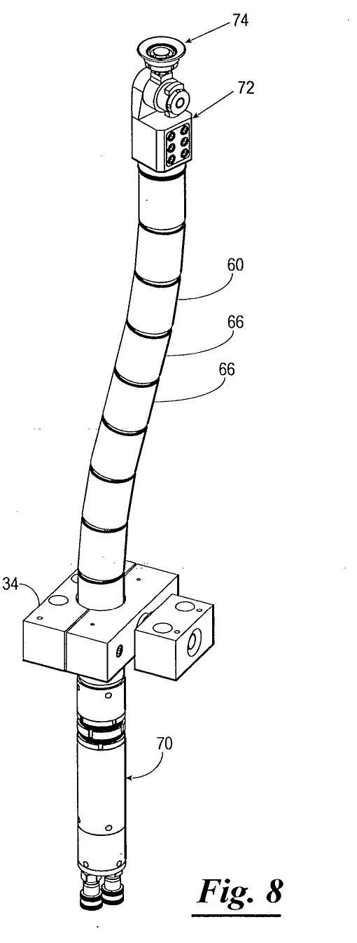

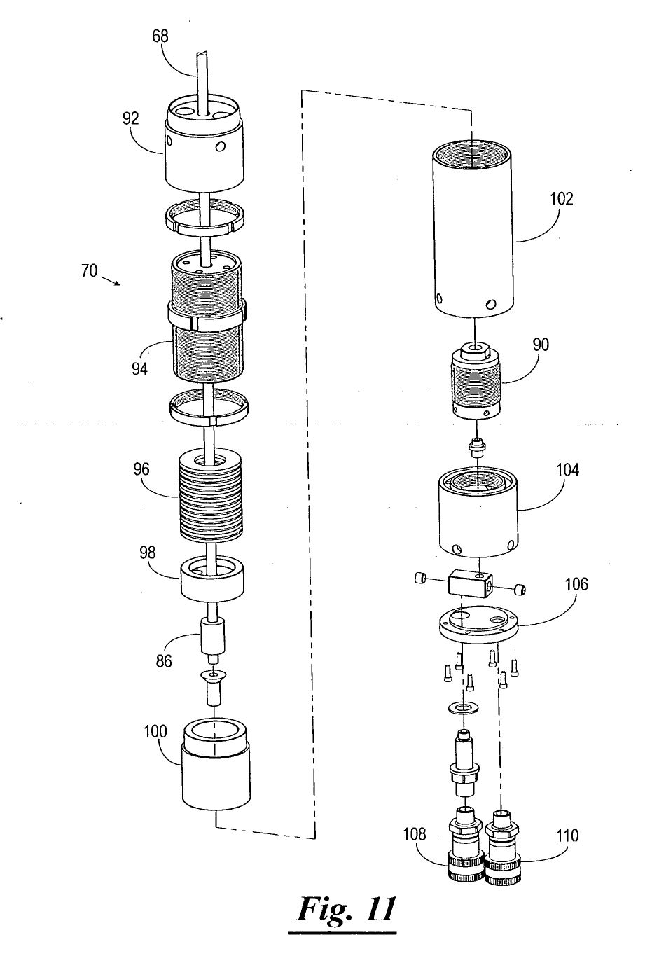

Referring now to FIGS. 8-11, the workpiece support 60 includes a plurality of swivel segments 66 linked together with a flexible tensioning cable 68 (FIG. 11), a cable clamping assembly 70, a pivot clamp assembly 72, and a suction cup assembly 74.

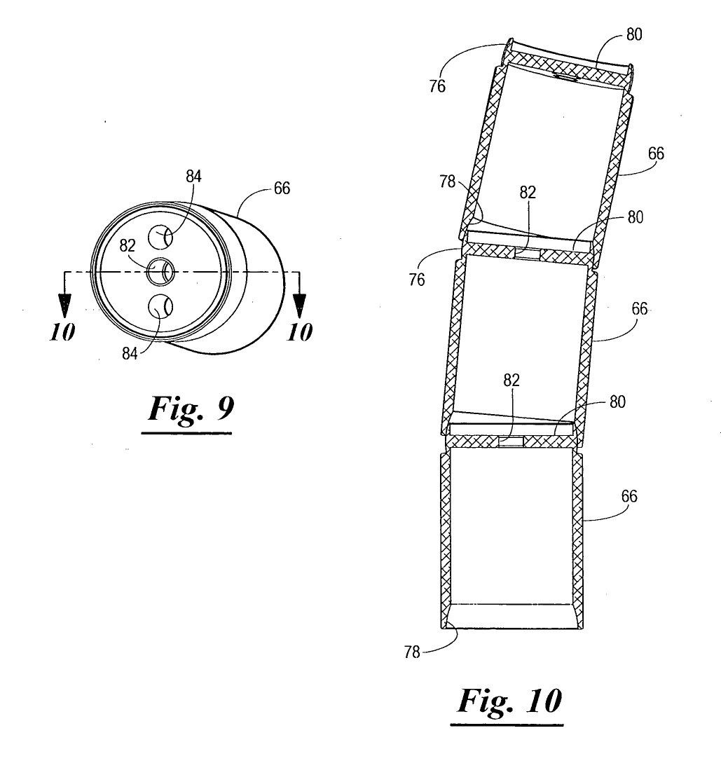

As best shown in FIG. 10, the swivel segments 66 are generally hollow, cylindrical members with a ball end 76 and a socket end 78. The ball end 76 is sized and adapted to be received in the socket end 78 of an adjacent swivel segment 66 so as to permit universal movement of one swivel segment 66 relative to the adjacent swivel segment 66. Each swivel segment 66 includes a cable centering flange 80 provided with a central cable receiving passage 82 and a pair of vacuum passages 84.

A selected number of swivel segments 66 are stacked on one another with the flexible tensioning cable 68 extending through the cable receiving passage 82 of each of the swivel segments 66. The.,lower end of the flexible tensioning cable 68 is provided with a cable stop filting 86 (FIG. 11) which in turn is retained within the cable clamp assembly 70. An upper end of the flexible tensioning cable 68 is retained within the pivot clamp assembly 72. In operation, the cable clamp assembly 70 permits the flexible tensioning cable 68 to be selectively tensioned whereby the swivel segments 66 are freely moveable relative to one another when the flexible tensioning cable 68 is in a non-tensioned state and the swivel segments 66 are maintained in a selected position due to friction interference between adjacent swivel segments 66 when the flexible tensioning. cable 68 is in a tensioned state.

Referring now to FIG. 11, the cable clamp assembly 70 utilizes a hydraulic actuator 90 to effect movement of the flexible tensioning cable 68 between the tensioned state and the non-tensioned state. The cable clamp assembly 70 further includes a top adjuster housing 92, a cable adjuster 94, a disc spring assembly 96, an upper piston 98, a lower piston 100 housed in a piston housing 102 and cooperating to permit the flexible tensioning cable 68 to be properly tensioned. The hydraulic actuator 90 is housed in a lower housing 104 which is closed with an endcap 106. The endcap 106 is adapted to receive a vacuum quick release coupler 108 and a hydraulic quick release coupler 110.

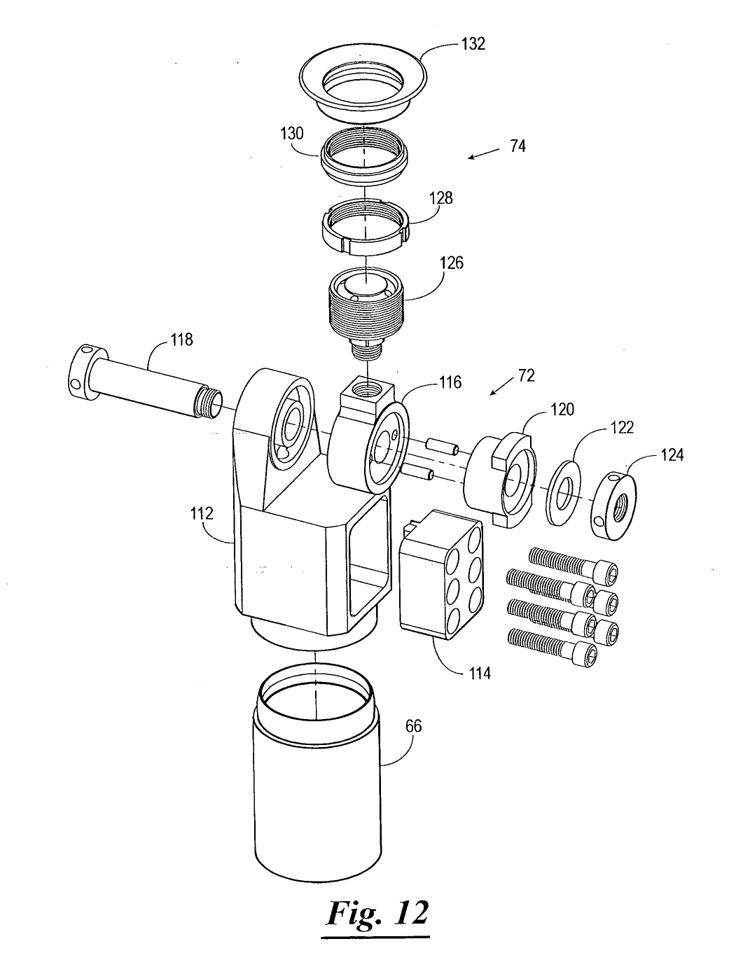

Referring now to FIG. 12, the pivot clamp assembly 72 and the suction cup assembly 74 are shown in greater detail. The pivot clamp assembly 72 includes a cable clamp housing 112 wherein the cable stop fitting (not shown) of the tension cable 68 is retained in cooperation with a cable clamp jaw 114. The cable clamp housing 112 is positioned on the upper most swivel segment 66.

A pivot arm 116 is pivotally attached to the cable clamp housing 112 by a pivot shaft 118. The position of the pivot arm 116 relative to the cable clamp housing 112 is adjusted by a gripper collar 120, a disc spring 122, and a shaft lock collar 124.

The suction cup assembly 74 includes a material datum 126 which is connected to the pivot arm 116 and is threaded to receive a suction cup locking ring 128, a suction cup adjuster 130, and a suction cup 132. The pivot clamp assemblies 72 and the suction cup assemblies 74 cooperate to enable workpieces with vertical surfaces (not shown) to be held. Due to the pivoting action of the suction cup assemblies 74 relative to the pivot clamp assembly 72, the suction cup assemblies 74 may support deeply contoured or even vertical surfaces. The working angles of the suction cup 132 are rigidly clamped via the pivot clamp assembly 72. This allows each suction cup assembly 74 to resist movement, as compared to suction cups mounted on unsecured pivots. This is useful for supporting narrow material areas with less than three clamps (for example) and for supporting portions of the workpiece that are cut out during the cutting process.

The workpiece supports 60 are positioned in a manner similar to that described above for the workpiece supports 16 with the exception that the processing machine 18 is utilized to actuate the cable clamp assembly 70 and to move the workpiece support 60 along the selected X, Y, and Z axis.

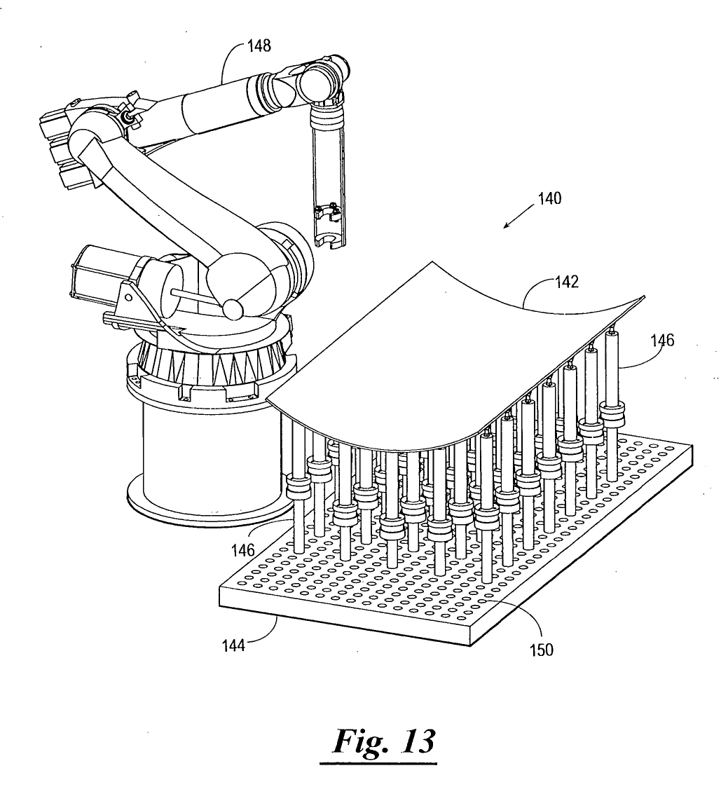

Referring now to FIG. 13, another embodiment of a workpiece holding apparatus 140 is illustrated. The workpiece holding apparatus 140 is shown supporting a workpiece 142. The workpiece holding apparatus 140 includes a support table 144, a plurality of workpiece supports 146 extending from the support table 144, and a processing machine 148. Like the workpiece holding apparatus 10 described above, the workpiece holding apparatus 140 utilizes the processing machine 148 to position the workpiece supports 146. The processing machine 148 is illustrated to be a robot. However, the processing machine 148 may also be a CNC machine as described above, or any other type of machine capable of moving the workpiece supports 146.

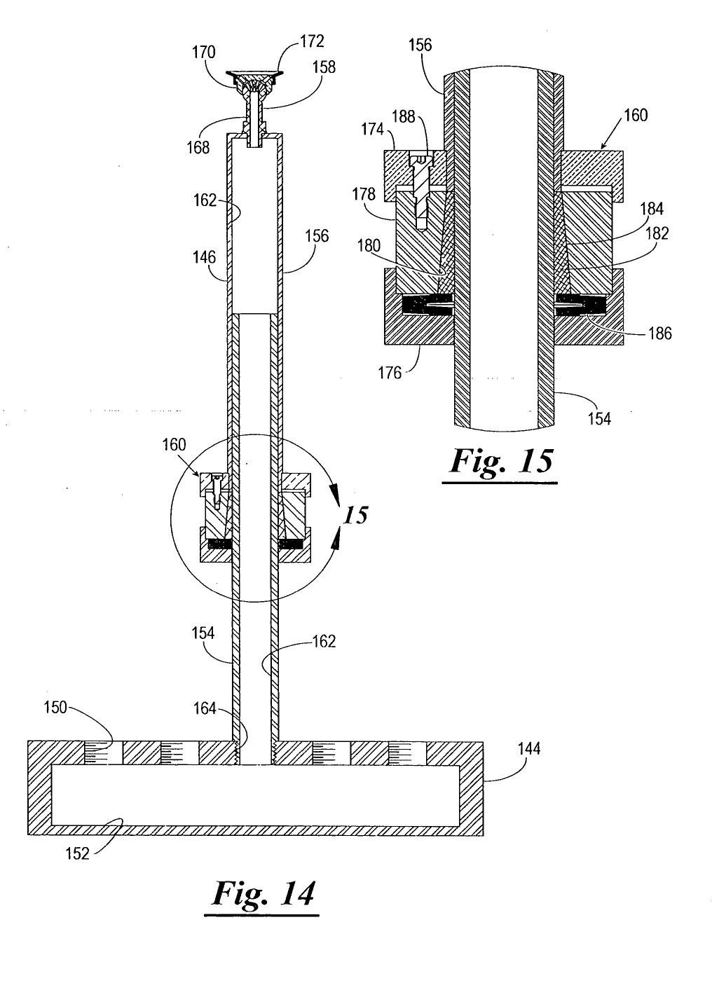

Referring now to FIGS. 13 and 14, the support table 144 has an upper surface with a plurality of apertures 150. The apertures 150 are in communication with a vacuum plenum 152 formed by the support table 144. The vacuum plenum 152 functions as a vacuum passage whereby a vacuum may be established to each workpiece support 146 upon connecting the workpiece support 146 to the support table 144. Rather than a vacuum hose being required to be connected to each workpiece support 146, the use of the support table 144 permits the vacuum supply hoses (not shown) to be connected directly to the support table 144. It should be appreciated that the support table 144 may be constructed to include a plurality of vacuum zones depending on the size of the support table 144.

The apertures 150 of the support table 144 are threaded, or otherwise adapted, to receive a workpiece support 146. It should be noted that the workpiece supports 146 are connected to the support table 144 such that the workpiece supports 146 extend from only one side of the support table 144, as opposed to extending from both sides of the support table 144 as do the workpiece supports 16 and the workpiece supports 60. As such, it is unnecessary for the support table 144 to be recessed to permit the workpiece 142 to be supported at a conventional height. Also, the apertures 150 are shown to be formed approximately four inches apart along the X and Y axis to provide the operator with more options, and thus greater flexibility, when positioning the workpiece supports 146 in the support table 144.

As best shown in FIGS. 14 and 15, the workpiece support 146 includes a base rod 154, an extension rod 156 which is telescopingly received over the base rod 154, a suction cup assembly 158, and a clamp assembly 160. The base rod 154 is provided with-a vacuum plenum 162 and a lower end 164 adapted to be connected to the support table 144 such that the vacuum plenum 162 of the extension rod 156 is in fluid communication with the vacuum plenum 152 of the support table 144.

The extension rod 156 is telescopingly received over the base rod 154. The extension rod 156 has an upper end to which the suction cup assembly 158 is connected and a lower end to which the clamp assembly 160 is attached. The extension rod 156 has a vacuum plenum 166 which is in communication with the vacuum plenum 162 of the base rod 154.

The suction cup assembly 158 includes a suction cup pivot 168, a material datum 170, and a suction cup 172. The suction cup pivot 168 and the material datum 170 cooperate to establish fluid communication with the vacuum plenum 166 of the extension rod 156.

Referring now to FIG. 15, the clamp assembly 160 is connected to the lower end of the extension rod 156 so as to be engageable with the base rod 154. The clamp assembly 160 includes an upper cap 174, a lower cap 176, a collar 178 with an inner tapered surface 180, a collet 182 having an outer tapered surface 184, and a spring 186. The lower cap 176 is biased from the upper cap 174, the collar 178 and the collet 182 by the spring 186. Compressing the upper cap 174 relative to the lower cap 176 results in the collar 178 moving relative to the collet 182 whereby the clamp force is removed from the collet 182 so that the extension rod 156 may be moved along the base rod 154 to a selected position. Upon reaching the selected position, the compressing force is removed from the upper cap 174 and the lower cap 176 whereby the collar 178 constricts the diameter of the collet 182 to force the collet 182 against the base rod 154. A plurality of slide pins 188 connect-the collar 178 to the upper cap 174.

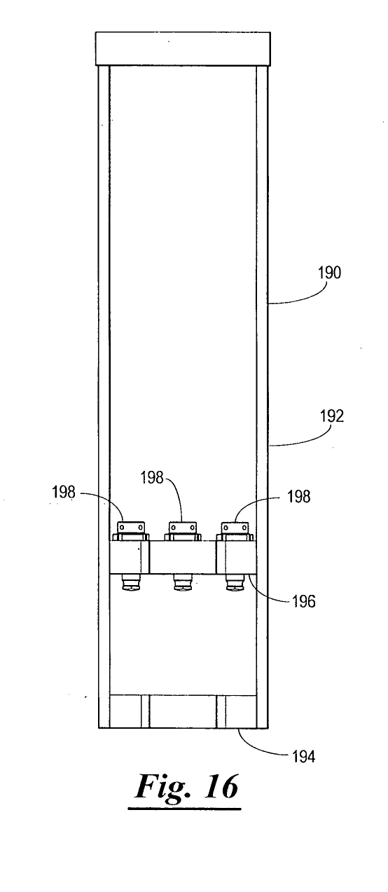

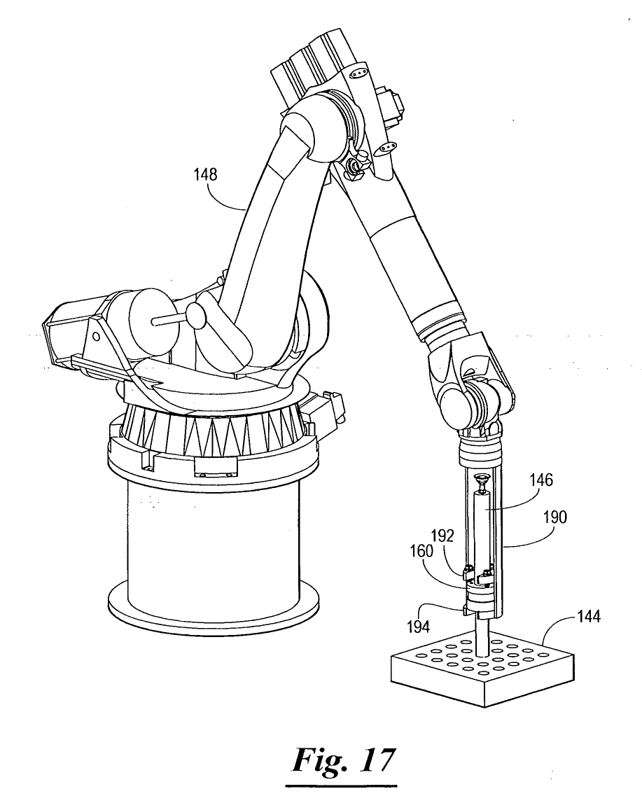

FIG. 16 depicts an end effector 190, and FIG. 17 depicts a workpiece support 146 being positioned by the processing machine 148 via the end effector 190 attached to the processing machine 148. The end effector 190 includes an open sided body 192, a lower fixed jaw 194, and an upper fixed jaw 196 provided with a plurality of actuators 198 for compressing the upper cap 174 and the lower cap 176 of the clamp assembly 160.

The following is an example of a sequence of steps that may be utilized to position a series of workpiece supports 146. This sequence utilizes a robot as the processing machine 148 to perform the positioning, but the sequence would be similar if a CNC machine were utilized instead. All movements and actuation performed by the processing machine 148 are processed by the control system utilized on that processing machine 148.
1. Processing machine operator removes selected aperture plugs from the support table 144 within XY area encompassed by the workpiece 142 required for processing.
2. Processing machine operator removes a plurality of workpiece supports 146 from workpiece support storage rack (not shown) and inserts the supports 146 into the support table 144 within the XY area encompassed by the workpiece 142 required for processing.
3. Processing machine 148 moves to an end effector storage location and docks with end effector 190.
4. Processing machine 148 with end effector 190 affixed moves to an XY position above workpiece support 146 extending from the support table 144 at the correct Z axis position to mate with the workpiece support 146.
5. Processing machine 148 moves with end effector 190 affixed until the end effector 190 is in the correct X axis position to mate with workpiece support 146 by the clamp assembly 160 being positioned between the lower jaw 194 and the upperjaw 196 of the end effector 190.
6. Processing machine 18 actuates the actuators 198 to cause the actuators 198 to compress the upper clamp assembly 160 and thereby disengage the clamp assembly 160.
7. Processing machine 148 raises extension rod 156 of the workpiece support 146 to a predetermined height corresponding to the contour of the workpiece 142 at this particular XY location.
8. Processing machine 148 releases the clamp assembly 160 to constrain the height of the extension rod 156 of the workpiece support 146.
9. Processing machine 148 unmates end effector 36 from workpiece support 146.
10. Processing machine 148 moves to an XY position above the next workpiece support 146 which requires vertical positioning.
11. Steps 4-10 are repeated until all workpiece supports 146 requiring positioning within XY area encompassed by the workpiece 142 are positioned.
12. Processing machine 148 moves to end effector storage location and undocks with end effector 190.
13. Operator places the workpiece 142 onto workpiece supports 146 and activates vacuum to hold the suction cup assemblies 158 to hold the workpiece 142.
14. Processing machine 148 performs normal cutting or assembly processes on the workpiece 142.
15. After the workpiece 142 process is completed the vacuum holding the workpiece 142 to workpiece supports 146 is released by the operator. Operator removes completed workpiece 142.
16. Steps 1-15 are repeated with each workpiece that requires different positioning of workpiece supports 146.

From the above description, it is clear that the present invention is well adapted to carry out the objects and to attain the advantages mentioned herein, as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and as defined in the appended claims.

What is claimed is:

1. An apparatus for holding a workpiece, comprising: a support table having a plurality of apertures;
a plurality of elongated workpiece supports positioned in at least a portion of the apertures of the support table;
a plurality of a clamp assemblies, each clamp assembly positioned about a portion of a corresponding workpiece support, the clamp assemblies moveable between a clamping position wherein the clamp assemblies secure at least a portion of the workpiece support in a selected vertical position and a non-clamping position wherein the workpiece supports are moveable so that the vertical position of the workpiece support is changeable; and
a processing machine in communication with the clamp assemblies to control the position of the clamp assemblies and having an end effector engageable with the workpiece supports above the support table to permit the processing machine to move the workpiece supports to selected positions when the clamp assemblies are in the non-clamping position.

2. The apparatus of claim 1, wherein the processing machine is a CNC machine.

3. The apparatus of claim 1, wherein the processing machine is a robot.

4. The apparatus of claim 1, wherein the clamp assemblies are positioned within the apertures of the support table.

5. The apparatus of claim 1, wherein each of the workpiece supports comprises a base rod and an extension rod positioned over the base rod in a telescoping relationship, and wherein one of the clamp assemblies is connected to a lower end of the extension rod so as to be positioned about the base rod.

6. The apparatus of claim 5, wherein the base rod has a lower end and an upper end, the lower end of the base rod being connected to the support table.

7. The apparatus of claim 6, wherein the support table defines a vacuum plenum in communication with each of the apertures of the support table and wherein the base rod and the extension rod each have a vacuum plenum extending longitudinally there through.

8. The apparatus of claim 7, wherein the workpiece supports further have a suction cup assembly positioned on an upper end of the extension rod, the suction cup assembly in fluid communication with the vacuum plenum of the extension rod, the base rod, and the support table.

9. The apparatus of claim 1, wherein at least one of the workpiece supports comprises:
a flexible tensioning cable having a first end and a second end;
a plurality of swivel segments stacked on one another with the tensioning cable extending through each of the swivel segments; and
a cable clamp assembly connected to the first end of the tensioning cable so as to selectively move the tensioning cable between a tensioned state and a non-tensioned state whereby the swivel segments are moveable relative to one another when the tensioning cable is in the non-tensioned state and the swivel segments are maintained in a selected position due to friction interference between adjacent swivel segments when the tensioning cable is in the tensioned state.

10. A method of forming a support for a workpiece, comprising:
providing a processing machine;
providing a support table;
positioning a plurality of workpiece supports in the support table;
connecting an end effector to the processing machine that is engageable with the workpiece supports above the support table;
engaging the end effector of the processing machine with one of the workpiece supports above the support table;
moving the workpiece support with the processing machine to position an upper end of the workpiece support at a selected position; and
clamping the workpiece support to secure the upper end of the workpiece support in the selected position.

11. The method of claim 10, wherein the step of clamping is in response to a command received from the processing machine.

12. The method of claim 10, wherein the step of moving the workpiece support comprises moving the upper end of the workpiece support such that the workpiece support is arranged in a non-linear configuration.

13. The method of claim 10, wherein the workpiece support is clamped with a clamp assembly and wherein the clamp assembly is disengaged from the workpiece support by the end effector of the processing machine.
